(19) United States
(12) Patent Application Publication
(10) Pub. No.: US 2005/0208270 A1
(43) Pub. Date: Sep. 22, 2005

(54) Support core ribbon for a cold-shrink tube

(75) Inventor: Tsung Mien Liang, Miao Li Hsien (TW)

Correspondence Address: TROXELL LAW OFFICE PLLC;SUITE 1404, 5205 LEESBURG PIKE, FALLS CHURCH, VA, 22041, US

(73) Assignee: Chardon Taiwan Corporation

(21) Appl. No.: 10/805,347

(22) Filed: Mar. 22, 2004

(51) Int. Cl. F16B 4/00

(52) U.S. Cl. 428/156

(57) ABSTRACT

A support core ribbon for a cold-shrink tube includes a continual ribbon to be wound helically. The continual ribbon has two edges of two longitudinal portions able to interlock with each other and welded together after wound helically. The ribbon further has a groove formed in an outer surface, and the groove has its lowest point with a thickness much smaller than that of the ribbon so the connecting force of the groove is far less that that of the interlocked and welded edges. Thus the ribbon may be easily ripped off at the groove in case the helically wound ribbon forming a tubular support core is pulled by an exterior force. Then the support core not only has a good supporting force but also a function of easily peeled off.

### BACKGROUND OF THE INVENTION

1. Field of the Invention

This invention relates to a cold-shrink tube, particularly to a support cord ribbon for the cold-shrink tube.

2. Description of the prior Art

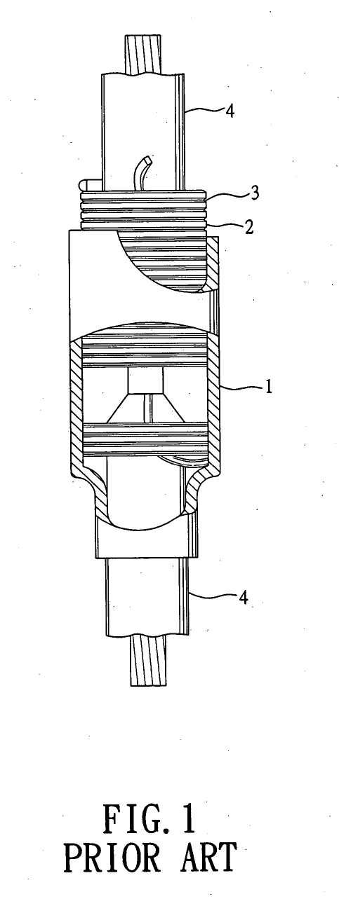

A cold-shrink tube is a polymeric tube possible to shrink automatically, mainly applied to a protective sleeve used for a jointed portion of an electric wire or a cable splice areas, and also applicable to a protective sleeve for a welded section of a tube. FIG. 1 shows a first conventional cold-shrink tube including an elastomeric tube 1 and a tubular core 2 positioned in the elastomeric tube 1 for supporting the elastomeric tube 1 under a swelled condition, The core 2 has continual helical groove 3 etched in its outer surface. When it is applied to a jointed section of two twisted-wire conductors 4, one end of the elastomeric tube 1 is fitted around one end of one of the twisted-wire conductors 4 and the other end of the elastomeric tube 1 is fitted around the core 2, which is then fitted around one end of the other twisted wire conductor 4. When the core 2 is pulled out to become a strip, the elastomeric tube 1 under the swelled condition may gradually shrink to its original condition, constricting the jointed section of the two twisted wire conductors 4. As the core 2 has to be etched with the helical groove 3, it costs much higher owing to its making process and is weakened in its strength as well.

In order to improve the disadvantage of the first conventional support core ribbon just described, a Taiwan patent of No. 264582 disclosed a kind of a support core ribbon for a cold-shrink tube, which includes a continual strip 10 provided with two edges 11, 12, which allow one edge 11 of one longitudinal portion to interlock with the opposite edge 12 of another longitudinal portion of the ribbon so that the ribbon may be helically wound into a cylindrical tube. Then the interlocking section is welded together by ultrasonic welding, making the cylindrical tube usable as a core for an elastomeric tube. In case that the cylindrical tube made of the band 10 is needed to be peeled off the round elastomeric tube, the jointed section of the two edges 11 and 12 are separated from each other, improving the disadvantage of the first conventional core for a cold-shrink tube. However, this second conventional support core ribbon for a cold-shrink tube has to be joined together by ultrasonic welding, which is hardly performed with the accuracy expected, whether what shape the two edges 11 and 12 may have. The reason is that the welding strength of ultrasonic welding is hard to control, with some portions of the ribbon 10 being too strong or too weak, hard to separate the interlocked and jointed sections or supporting strength being not sufficient.

### SUMMARY OF THE INVENTION

This invention will be better understood by referring to the accompanying drawings, wherein:

FIG. 1 is a front view of a first conventional cold-shrink tube used for a cable;

FIG. 2 is a cross-sectional view of a second conventional strip for a support core of a cold-shrink tube;

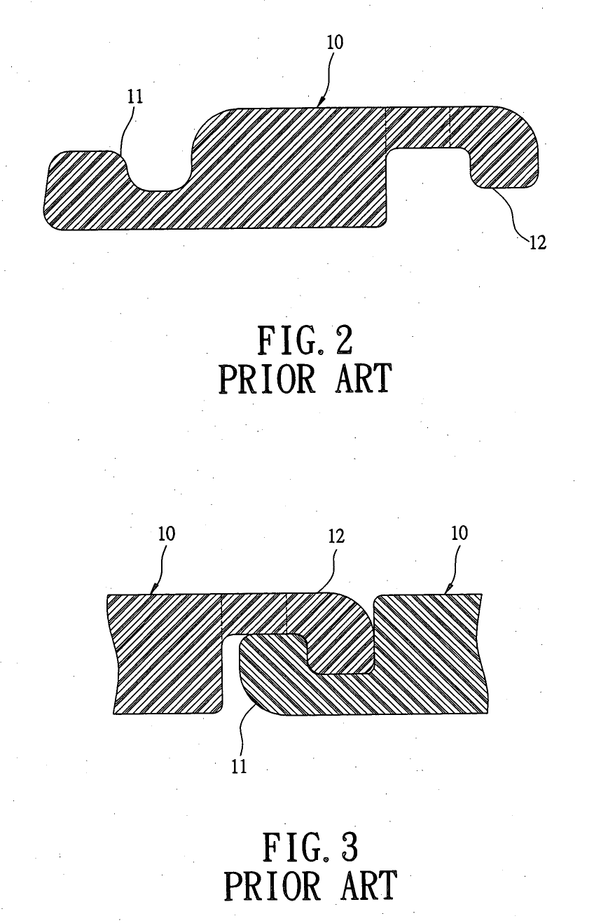

FIG. 3 is a cross-sectional view of the second conventional strip of the support core for a cold-shrink tube;

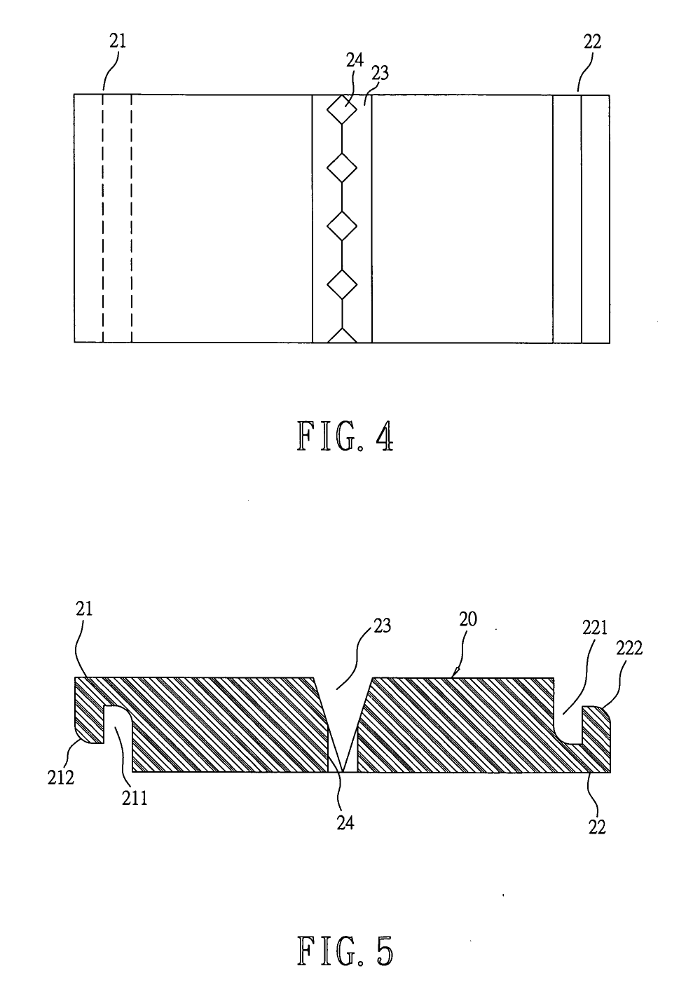

FIG. 4 is an upper view of a first preferred embodiment of a support core ribbon for a cold-shrink tube in the present invention;

FIG. 5 is a cross-sectional view of the first preferred embodiment of a support core ribbon for a cold-shrink tube in the present invention;

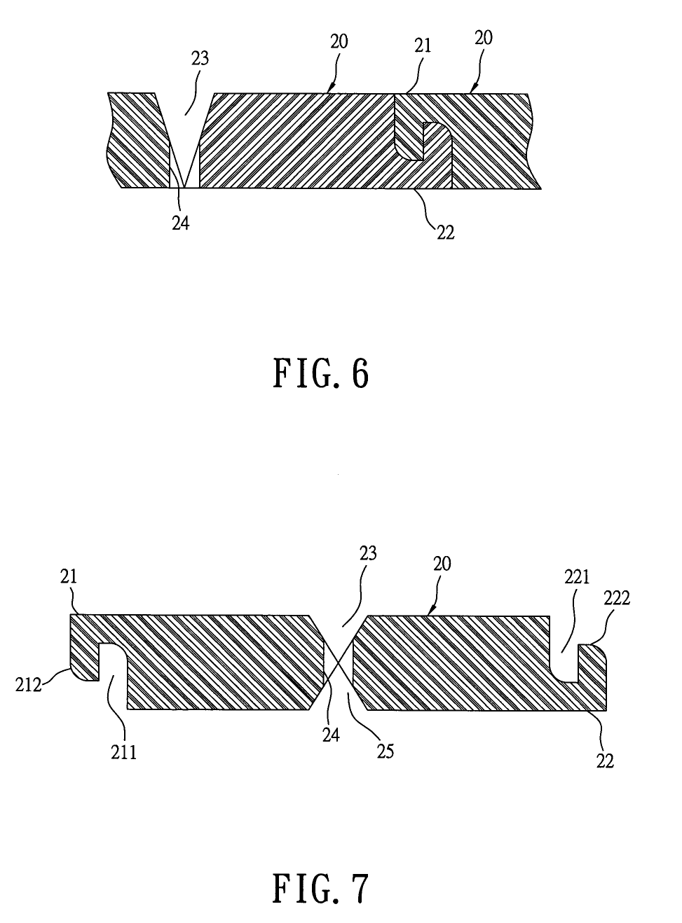

FIG. 6 is a cross-sectional view of the ribbon of the first preferred embodiment in the present invention, showing two edges of different longitudinal portions interlocked with each other; and,

FIG. 7 is a cross-sectional view of a second preferred embodiment of a support core ribbon for a cold-shrink tube in the present invention.

### DETAILED DESCRIPTION OF THE PREFERRED EMBODIMENTS

A first preferred embodiment of a support core ribbon for a cold-shrink tube in the present invention, as shown in FIGS. 4 and 5, includes a continual ribbon 20 to be wound around helically to form the support core.

The continual ribbon 20 is flat, having two formed edges 21 and 22. The first formed edge 21 has a first straight groove 211 defined by and positioned behind a first projecting portion 212 and opening to the lower side, and the second formed edge 22 has a second straight groove 221 defined by and positioned behind a second projecting portion 222 and opening to the upper side. Then the first groove 211 can fit with the second projecting portion 222 and the second groove 221 can fit with the first projecting portion 211 so the first formed edge 21 can interlock with the second formed edge 22. Then the interlocked section can be welded together by means of ultrasonic welding. The ribbon 20 further has a single-V-shaped groove 23 formed in the intermediate lengthwise portion, with the thickness of the lowest point of the groove 23 being very smaller than the thickness of the ribbon 20. The V-shaped groove 23 has a plurality of square holes spaced apart equidistantly in its intermediate lengthwise portion.

Next, when the continual ribbon 20 is wound helically to form a tubular support core, the two edges 21 and 22 are made to interlock with each other and then welded together by ultrasonic welding, making up a tubular support core. In case that the wound ribbon 20 forming the tubular support core is wanted to be peeled off, the ribbon 20 may easily be automatically ripped off at the V-shaped groove 23 by an external force added to pull the ribbon 20, as the V-shaped groove 23 is the weakest point of the ribbon 20. Then the helical ribbon 20 formed into the tubular support core may peel off of itself slowly.

FIG. 7 shows a second preferred embodiment of a support core ribbon for a cold-shrink tube in the present invention, which has the almost same structure as the first preferred embodiment, except that a groove of a double-V-shape 25 is used instead of the single-V-shaped groove 23 in the first preferred embodiment. Then the double-V-shaped groove 25 is the weakest point of the ribbon 20 for making up a tubular support core for a cold-shrink tube.

As the single-V-shaped groove 23 or the double-V-shaped groove 25 respectively in the first and the second preferred embodiment is not so near the two formed edges 21 and 22, so long as the continual ribbon 20 has some real thickness for the groove 23 or 25, it may have the highest support strength as a whole and the lowest strength sustainable for the groove 23 or 25 when wound into a tubular support core. Then the invention has two advantages that the helically wound ribbon making up a tubular support core for a cold-shrink tube has a good support strength for an elastomeric tube and a function of easily to be peeled off.

While the preferred embodiments of the invention have been described above, it will be recognized that various modifications may be made therein and the appended claims are intended to cover such modifications that may fall within the spirit and scope of the invention.

1. A support core ribbon for a cold-shrink tube, said cold-shrink tube including an elastomeric tube and a tubular support core deposited in said elastomeric tube for supporting said elastomeric tube said tubular support core formed by a continual ribbon wound helically, said helically wound ribbon having two formed edges of two longitudinal portions interlocking with each other and welded together:
Said ribbon characterized by at least a groove formed in one outer surface, said groove having a lowest point of a thickness far smaller than that of said ribbon, said groove having connecting force far less than that of said two formed edges of two longitudinal portions interlocking with each other, said ribbon easily ripping off at said groove in case of said helical wound ribbon forming said tubular support core pulled by an exterior force.

2. The support core ribbon for a cold-shrink tube as claimed in claim 1, wherein said groove has a plurality of holes spaced apart equidistantly in its intermediate portion.

3. The support core ribbon for a cold-shrink tube as claimed in claim 1, wherein said groove is single-V-shaped.

4. The support core ribbon for a cold-shrink tube as claimed in claim 1, wherein one of said two edges is provided with a first straight groove formed in a lower surface of said ribbon and defined by a first projecting portion, and the other of said two edges is provided with a second straight groove in an upper surface of said ribbon and defined by a second projection.

5. The support core ribbon for a cold-shrink tube as claimed in claim 1, wherein said two edges are welded together by means of ultrasonic welding after interlocking with each other.
